(19) United States
(12) Patent Application Publication
(10) Pub. No.: US 2008/0288696 A1
(43) Pub. Date: Nov. 20, 2008

(54) DEVICE WITH A PROCESSOR AND A PERIPHERAL UNIT AND METHOD FOR GENERATING AN ACKNOWLEDGMENT SIGNAL

(76) Inventor: Christof Abt, Backnang (DE)

Correspondence Address: Muncy, Geissler, Olds & Lowe, PLLC, P.O. BOX 1364, FAIRFAX, VA, 22038-1364, US

(21) Appl. No.: 12/122,799

(22) Filed: May 19, 2008

Related U.S. Application Data
(60) Provisional application No. 60/941,279, filed on May 31, 2007.

(30) Foreign Application Priority Data
May 19, 2007 (DE) DE 102007023442.4

(51) Int. Cl. G06F 13/24

(52) U.S. Cl. 710/267

(57) ABSTRACT

A device is provided that includes a processor, a peripheral unit, and a first logic, and to a method for generating an acknowledgment signal. The processor is clocked by a processor clock signal, which runs asynchronously to the peripheral clock signal, by which the peripheral unit is clocked. The peripheral unit sends an interrupt request synchronously to the peripheral clock signal to the processor, which thereupon is woken up from its idle state, to process the interrupt request in its working state. After the processing or during the processing of the interrupt request, the processor generates an acknowledgment signal synchronous to the processor clock signal. The first logic generates an acknowledgment signal, which is synchronous to the peripheral clock signal and by which the peripheral unit is informed about the processed interrupt request, from the acknowledgment signal synchronous to the processor clock signal.

This nonprovisional application claims priority to German Patent Application No. DE 10 2007 023 442.4, which was filed in Germany on May 19, 2007, and to U.S. Provisional Application No. 60/941,279, which was filed on May 31, 2007, and which are both herein incorporated by reference.

### BACKGROUND OF THE INVENTION

1. Field of the Invention

The invention relates to a device with a processor and a peripheral unit and to a method for generating an acknowledgment signal.

2. Description of the Background Art

Particularly in embedded systems, the processor of the system is most often in a power-saving sleep or idle state, from which it is woken up during an interrupt request stemming from a peripheral unit of the system. After waking up, the processor processes the interrupt request and acknowledges it. Particularly when the peripheral units are clocked by a slower clock than the processor, it is possible that the peripheral unit from which the interrupt request stems does not receive the acknowledgment and perhaps again sends the interrupt request to the processor. As a result, the processor is woken up again unnecessarily, which has a negative impact on the system's power consumption.

From DE 101 27 424, an electric circuit is known that has an asynchronous clock for peripheral units. From DD 299 782 A7 a synchronization device is known for different components that have microprocessors. A further electric circuit to control the used energy by electric components is known from EP 1 785 810 A1.

### SUMMARY OF THE INVENTION

The object of the invention therefore is to design a device and a peripheral unit to generate an interrupt request by means of which the device can be operated in a power-saving manner.

The object of the invention is attained by means of a device comprising a processor, which is clocked by means of a processor clock signal and can be woken up from its idle state based on an interrupt request, to process the interrupt request in its working state and after the processing or during the processing of the interrupt request to generate an acknowledgment signal synchronous to the processor clock signal; at least one peripheral unit, which is clocked by means of a peripheral clock signal, which runs asynchronously to the processor clock signal, and which sends the interrupt request to the processor synchronously to the peripheral clock signal; and a first logic, which generates an acknowledgment signal, which is synchronous to the peripheral clock signal and by which the peripheral unit is informed about the process interrupt request, from the acknowledgment signal synchronous to the processor clock signal.

The object is also attained by a method for generating an acknowledgment signal, said method including at least some of the process steps: generation of an interrupt request synchronous to a peripheral clock signal by means of a peripheral unit, which is clocked by the peripheral clock signal; waking up of a processor based on the interrupt request, so that said processor changes from its idle state to its working state to process the interrupt request, whereby the processor is clocked by a processor clock signal, running asynchronously to the peripheral clock signal; generation of an acknowledgment signal synchronous to the processor clock signal, after the processor has processed the interrupt request or while the processor is processing the interrupt request; and/or generation of an acknowledgment signal synchronous to the peripheral clock signal from the acknowledgment signal synchronous to the processor clock signal by means of a first logic to inform the peripheral unit about the processed interrupt request.

The device of the invention comprises the processor and the at least one peripheral unit. The peripheral unit and the processor are each clocked by different clock signals asynchronous to one another. The processor is usually in its power-saving idle state and is woken up based on the interrupt request stemming from the peripheral unit, to process the interrupt request in its working state. During the processing or after the interrupt request has been processed, the processor generates the acknowledgment signal synchronous to the processor clock signal, therefore, an acknowledgment signal synchronous to the processor, which is provided inter alia to inform the peripheral unit about the processing of the interrupt request, so that said unit, for example, does not again send the interrupt request. Because of the acknowledgment signal, the peripheral unit, e.g., is set back and does not again send the interrupt request. The acknowledgment signal synchronous to the processor clock signal can also be used to again place the processor in its idle state.

The processor and the peripheral unit work asynchronously to one another. In particular, the processor can work with a more rapid clock than the peripheral unit; i.e., in particular the clock frequency of the peripheral clock signal can be smaller than the clock frequency of the processor clock signal. This can result in a power saving of the device of the invention, because the peripheral unit due to the slower clocking consumes potentially less energy than when it would be clocked at a higher frequency. The processor, on the other hand, is most often in its idle state and is in its working state only for processing the interrupt request. Clocking at a higher clock frequency therefore has only relatively little impact on the power consumption.

Particularly when the processor is clocked at a higher frequency than the peripheral unit, it is possible that the acknowledgment signal synchronous to the processor clock signal is no longer available at the time of the next clock cycle of the peripheral unit and the peripheral unit does not receive the acknowledgment signal. To avoid this, the device of the invention comprises the first logic, which generates the acknowledgment signal synchronous to the peripheral clock signal from the acknowledgment signal synchronous to the processor clock signal. The requirements are therefore met that the peripheral unit reliably receives its acknowledgment signal and accordingly does not again inadvertently direct the same interrupt request to the processor.

According to an embodiment, the first logic comprises a first flip-flop, which is clocked by the processor clock signal and whose input signal is at least indirectly the acknowledgment signal synchronous to the processor clock signal, and a second flip-flop for generating the acknowledgment signal which is synchronous to the peripheral clock signal and is clocked by the peripheral clock signal and whose input signal is the output signal of the first flip-flop. The acknowledgment signal synchronous to the processor clock signal is virtually captured by the first flip-flop of the first logic and then synchronized by means of the second flip-flop in such a way that it is synchronous to the peripheral clock signal. According to this variant, the first flip-flop of the first logic can be supplied directly with the acknowledgment signal synchronous to the processor clock signal or a signal is supplied that is derived from the acknowledgment signal synchronous to the processor clock signal.

Instead of the second flip-flop, at least two flip-flops connected one behind the other can be used. This increases the stability of the first logic.

According to an embodiment, the device can have a second logic, which generates from the interrupt request, sent synchronously to the peripheral clock signal, an interrupt request which runs synchronously to the processor clock signal and is supplied to the processor. The interrupt request stemming from the peripheral unit is synchronous to the peripheral clock signal and asynchronous to the processor clock signal. Particularly when the used processor interrupt request can be processed only synchronously to its processor clock signal, based on this embodiment the requirements arise that the processor reliably receives the interrupt request.

The second logic can have a shift register whose input signal is the interrupt request sent synchronously to the peripheral clock signal or a signal synchronous to this signal, a logic connected downstream to the shift register for detecting an edge of the output signal of the shift register, and a flip-flop, which is clocked by the processor clock signal, whose input signal is the output signal of the logic for detecting an edge and whose output signal is the interrupt request running synchronously to the processor clock signal. The shift register has, for example, at least two series-connected flip-flops, which are clocked by the processor clock signal. In particular, this shift register has at least three series-connected flip-flops, as a result of which the stability of the shift register can be increased. As a result, requirements are created that the downstream logic for detecting an edge of the output signals of the shift reliably detects the edge, which is particularly a rising edge.

The second logic can also be made in such a way that it generates a wake-up signal for the processor from the interrupt request sent synchronously to the peripheral clock. This wake-up signal, for example, turns on a clock generator to generate the processor clock signal, as a result of which the processor is switched from its idle state to its working state.

The device of the invention can be used, for example, for wheel electronics. Wheel electronics are generally provided to determine at least one tire parameter of the tire. The tire parameter is, for example, the tire pressure of the tire. The wheel electronics of the invention have, apart from the device of the invention, at least one sensor for determining the tire parameter and a transmitter, whereby the processor based on the interrupt request determines the tire parameter by means of the sensor and generates a message about the tire parameter, which the transmitter sends.

Wheel electronics are integrated, for example, into a tire or disposed on a rim on which the tire is mounted. During operation of the vehicle equipped with these tires, the wheel electronics can determine particularly automatically the tire pressure of the respective tire and transmit this wirelessly to a control unit disposed in the vehicle. Based on the determined tire pressure, the control unit can determine, for example, whether the tire pressure of one of the tires is too low, in order to inform, if necessary, the person driving the vehicle about the too low tire pressure.

According to an embodiment of the wheel electronics of the invention, the peripheral unit is a timer and/or a receiver. The timer is provided, for example, for periodically generating the interrupt request, so that the wheel electronics periodically send the message about the tire parameter by means of its transmitter to the control unit. The receiver can be provided for generating the interrupt request based on a received signal. The received signal stems, for example, from the control device disposed in the vehicle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle whose tires are assigned tire electronics,

FIG. 2 shows tire electronics,

FIG. 3 shows a subcircuit of the tire electronics, and

FIG. 4 shows signal curves.

### DETAILED DESCRIPTION

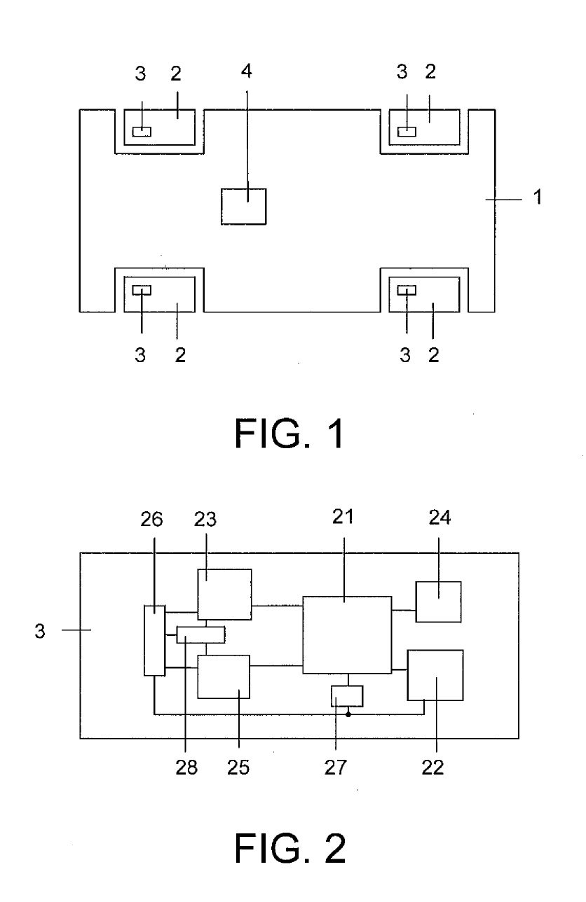

FIG. 1 shows a motor vehicle 1 with four tires 2, each of which is assigned wheel electronics 3 shown in greater detail in FIG. 2. Wheel electronics 3 can be integrated, e.g., in the respective tires 2 or, for example, be disposed on the rim on which tires 2 are mounted. Wheel electronics 3 are provided, inter alia, to measure the tire pressures of respective tires 2 and to transmit wirelessly information on the measured tire pressures to control unit 4 disposed in motor vehicle 1. Control unit 4 processes this information and informs, e.g., a person driving the motor vehicle when one of the tire pressures is too low. Wheel electronics 3 are an example of a device with a processor and at least one peripheral unit.

In the case of the present exemplary embodiment, each of the wheel electronics 3 has a processor 21, a transmitter 22, a timer 23, a pressure sensor 24, a receiver 25, and a battery 26. Processor 21 is, e.g., a microcontroller or a microprocessor and battery 26 supplies processor 21, transmitter 22, receiver 25, and timer 23 with electrical energy.

In the case of the present exemplary embodiment, it is provided that wheel electronics 3 periodically send information on the current tire pressure of its tire 3 by means of its transmitter 22 to control unit 4. It is provided in addition that control unit 4 can send a request to wheel electronics 3, on the basis of which wheel electronics 3 determine the tire pressure of its tires 3 and transmits this by means of its transmitter 22 to control unit 4. Wheel electronics 3 receive these requests with receivers 25.

In the case of the present exemplary embodiment, processor 21 by means of pressure sensor 24 determines the tire pressure and generates a message on the tire pressure, which is transmitted by means of transmitter 22 to control unit 4. To save energy, processor 21 is usually in a power-saving sleep or idle state. Only when it is to generate a message on the tire pressure, is it woken up by means of interrupt requests, namely, either periodically by timer 23 or optionally by a receiver 25. Timer 23 and receiver 25 therefore represent peripheral units that direct interrupt requests to processor 21.

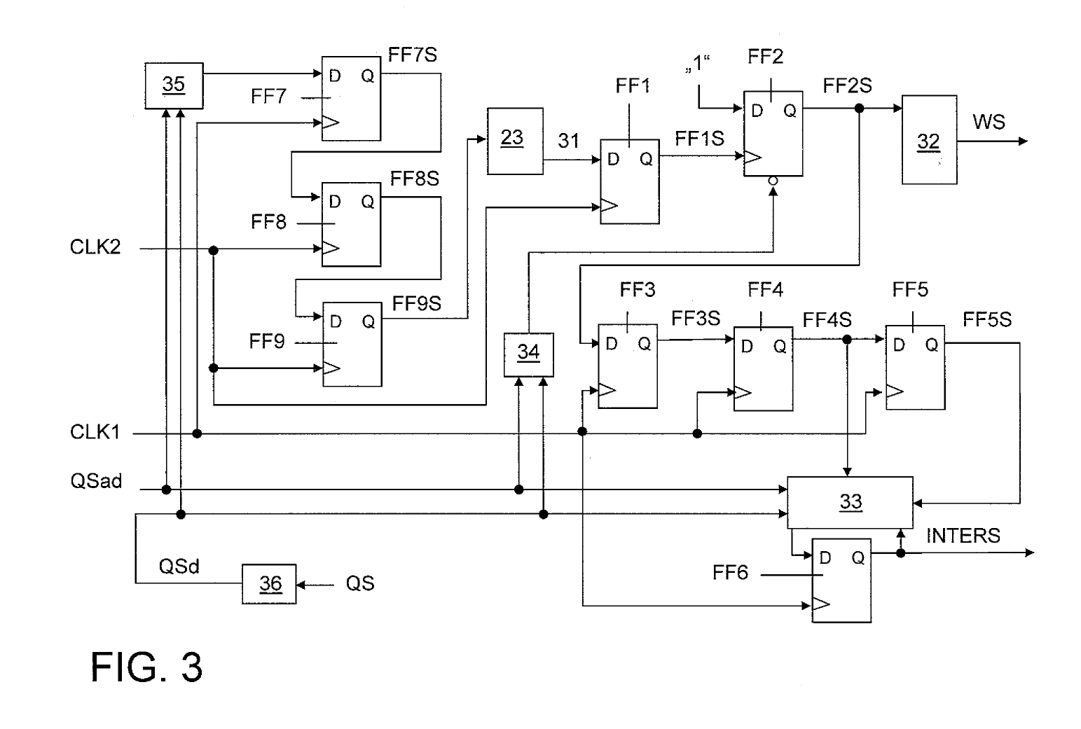

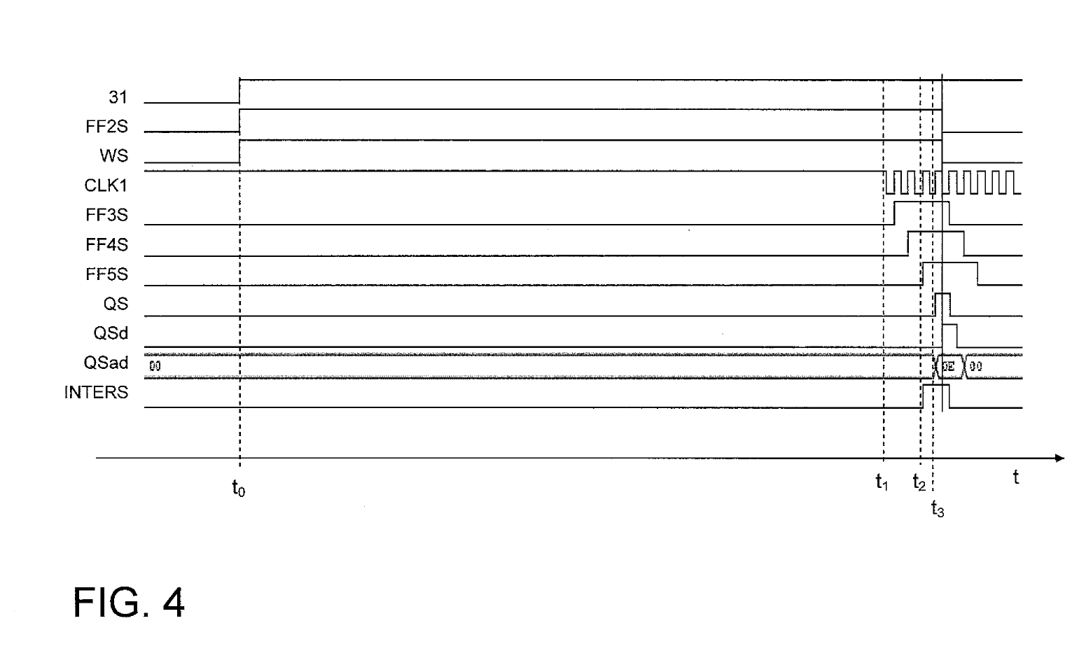

Based on an interrupt request, processor 21 is woken up, therefore shifted from its idle state to its working state, to process the interrupt request. If the interrupt request is processed, the processor then generates an acknowledgment signal, by which it informs the respective peripheral unit about the processed interrupt request. Alternatively, the acknowledgment signal can be generated even before the processing of the interrupt request. The acknowledgment signal is also used to shift processor 21 again to its idle state, except when there is still another interrupt request. FIG. 3 shows a circuit which implements this scenario in the case of the present exemplary embodiment, and FIG. 4 shows signal curves inter alia of the acknowledgment signal QS generated by processor 21.

When processor 21 is in its working state, it is clocked by a processor clock signal CLK1, which in the case of the present exemplary embodiment is generated by means of a first clock generator 27. First clock generator 27 is also normally in the idle state, is woken up by a wake-up signal WS, to generate the processor clock signal CLK1, and is supplied with power by battery 26. Processor clock signal CLK1 has, for example, a clock frequency of 4 MHz.

The peripheral units, therefore receiver 25 and timer 23, in contrast to processor 21, are constantly in their working states and are constantly clocked by peripheral clock signals CLK2. In this case, it is possible, e.g., that timer 23 and receiver 25 are each clocked by different peripheral clock signals or, as provided in the case of the present exemplary embodiment, by the same peripheral clock signal CLK2. The peripheral clock signal is generated, e.g., by a second clock generator 28 and the clock frequency of the peripheral clock signal CLK2 is much smaller than the clock frequency of processor clock signal CLK1. The clock frequency of peripheral clock signal CLK2 is, for example, 90 kHz.

When one of the peripheral units would like to ask processor 21 to generate a message on the current tire pressure, then this peripheral unit, e.g., timer 23, generates a signal 31, which is supplied to a first flip-flop FF1. The first flip-flop FF1 is clocked by peripheral clock signal CLK2 of the respective peripheral unit, therefore timer 23 in this case. The output signal of the first flip-flop FF1 is supplied as a clock signal to a second flip-flop FF2, whose input is set to logic “1,” so that the output signal FF2S of the second flip-flop FF2 is set to “1” with the rising edge of the output signal FF1S of the first flip-flop FF1. The output signal FF2S of the second flip-flop FF2 is supplied to an OR gate 32, at whose output the wake-up signal WS for the first clock generator 27 of processor 21 is applied. Another input signal, not shown in greater detail in FIG. 3, for OR gate 32 comes from receiver 25; i.e., the wake-up signal WS to wake up the first clock generator 27 becomes logic “1”, when timer 23 or receiver 25 has an interrupt command for processor 21. When the wake-up signal WS for the first clock generator 27 switches from logic “0” to logic “1,” the first clock generator 27 after a certain time begins to generate the processor clock signal CLK1, so that processor 21 switches from its idle state to its working state. In the case of the present exemplary embodiment, the wake-up signal is generated at time to and the processor clock signal CLK1 at time t₁.

The output signal FF2S of the second flip-flop FF2 is supplied in addition to a shift register chain, which in the case of the present exemplary embodiment has a third, fourth, and fifth flip-flop FF3, FF4, FF5, each of which is clocked by processor clock signal CLK1. In this case, the third flip-flop FF3 generates an output signal FF3S, the fourth flip-flop FF4 an output signal FF4S, and the fifth flip-flop FF5 an output signal FF5S.

The output signals FF4S, FF5S of the fourth and fifth flip-flop FF4, FF5 are supplied to a logic 33, which in the case of the present exemplary embodiment detects a rising edge of output signal FF5S of fifth flip-flop FF5 and thereupon applies logic “1” to the input of a sixth flip-flop FF6, which is also clocked by processor clock signal CLK1. The output signal of the sixth flip-flop FF6 is the interrupt signal INTER, which is present at time t₂ and because of which processor 21 begins to process the interrupt request of timer 23.

In the case of the present exemplary embodiment, the shift register, having the third, fourth, and fifth flip-flop FF3-FF5, and the sixth flip-flop FF6 make sure that the interrupt signal INTER runs synchronously to processor 21.

When processor 21 has processed the interrupt request, it then generates the acknowledgment signal QS and an address signal QSad, by means of which the peripheral unit that has made the interrupt request is addressed. In the case of the present exemplary embodiment, the addressing signal QSas is intended for timer 23. So that the address signal QSad is not present until after the acknowledgment signal QS has been generated, it is shifted by means of a delay element 36 by half a processor clock CLK1, as a result of which the acknowledgment signal QSd arises, which like acknowledgment signal QS is synchronous to processor clock CLK1.

In the case of the present exemplary embodiment, processor 21 generates the acknowledgment signal QS at time t₃. The address signal QSad is generated at the same time t₃.

The delayed acknowledgment signal QAd and the address signal QSad are supplied to logic 33 and to another logic 34. Logic 34 sets the second flip-flop FF2 back, so that the output signal FF2S of the second flip-flop FF2 is again set back to logic “0” and the wake-up signal WS is again turned off, except when there is another interrupt request, e.g., from receiver 25. Therefore, processor 21 is again set back to its idle state. Therefore, the part of wheel electronics 3 that is synchronous to processor clock signal CLK1 after processing of the interrupt request detects that the interrupt request was processed.

In order for the peripheral unit which originated the interrupt request to also receive information about the processed interrupt request, wheel electronics 3 have a seventh, eighth, and ninth flip-flop FF7-FF9, of which the seventh flip-flop FF7 is clocked by processor clock signal CLK1 and the eighth and ninth flip-flop FF8, FF9 by peripheral clock signal CLK2.

In the case of the present exemplary embodiment, the acknowledgment signal QS and the address signal QSad are first supplied to a logic 35, which inter alia evaluates the address signal QSad as to whether the acknowledgment signal QS is intended for timer 23.

If the acknowledgment signal QS is intended for timer 23, then the input signal of the seventh flip-flop FF7 is set to logic “1” and the acknowledgment signal QS is captured synchronously to processor clock signal CLK1. The output signal FF7S of the seventh flip-flop FF7 clocked by means of processor clock signal CLK1 is supplied to the eighth flip-flop FF8, which is clocked by peripheral clock signal CLK2. The output signal FF8S of the eighth flip-flop FF8 is supplied to the ninth flip-flop FF9, which is also clocked by peripheral clock signal CLK2. The output signal FF9S of the ninth flip-flop F9 is synchronous to peripheral clock signal CLK2 and is supplied to timer 23 as an acknowledgment signal.

Thus, the seventh flip-flop FF7 captures the acknowledgment signal QS generated by processor 21 and running synchronously to the processor clock CLK1. The eighth and ninth flip-flop FF8, FF9 synchronize the acknowledgment signal QS for timer 23, i.e., generate the output signal FF9S, which runs synchronously to the peripheral clock signal CLK2, therefore to timer 23, as the acknowledgment signal for timer 23. Wheel electronics 3 can now again receive a new interrupt request.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device comprising
a processor that is clocked by a processor clock signal and is woken up from an idle state, based on an interrupt request, to process the interrupt request in a working state, and after the processing or during the processing of the interrupt request the processor generates an acknowledgment signal synchronous to the processor clock signal;
at least one peripheral unit, which is clocked by a peripheral clock signal that runs asynchronously to the processor clock signal, and which sends the interrupt request to the processor synchronously to the peripheral clock signal; and
a first logic that generates an acknowledgment signal, which is synchronous to the peripheral clock signal, and by which the peripheral unit is informed about the processed interrupt request from the acknowledgment signal synchronous to the processor clock signal.

2. The device according to claim 1, wherein the first logic has a first flip-flop, which is clocked by the processor clock signal and whose input signal is at least indirectly the acknowledgment signal synchronous to the processor clock signal, and wherein the first logic has a second flip-flop for generating the acknowledgment signal, which is synchronous to the peripheral clock signal and is clocked by the peripheral clock signal and whose input signal is the output signal of the first flip-flop.

3. The device according to claim 2, wherein the first logic has a plurality of second flip-flops connected one behind the other, each of which is clocked by the peripheral clock signal, and wherein the output signal of the last connected second flip-flop represents the acknowledgment signal synchronous to the peripheral clock signal.

4. The device according to claim 1, wherein a second logic, which generates from the interrupt request, sent synchronously to the peripheral clock signal, an interrupt request that runs synchronously to the processor clock signal and is supplied to the processor.

5. The device according to claim 4, wherein the second logic has a shift register whose input signal is the interrupt request sent synchronously to the peripheral clock signal or a signal synchronous to the interrupt request sent to the peripheral clock signal, wherein the second logic has a logic connected downstream to the shift register for detecting an edge of the output signal of the shift register, and wherein the second logic has a flip-flop, which is clocked by the processor clock signal, whose input signal is the output signal of the logic for detecting an edge and whose output signal is the interrupt request running synchronously to the processor clock signal.

6. The device according to claim 1, wherein the device determines at least one tire parameter of a tire of a vehicle, the device further comprising at least one sensor for determining the tire parameter, and a transmitter, wherein the processor based on the interrupt request determines the tire parameter via the sensor and generates a message about the tire parameter that the transmitter sends.

7. A method for generating an acknowledgment signal, the method comprising the steps of:
generating an interrupt request synchronous to a peripheral clock signal by a peripheral unit, which is clocked by the peripheral clock signal;
waking up of a processor based on the interrupt request, so that the processor changes from an idle state to a working state to process the interrupt request, wherein the processor is clocked by a processor clock signal running asynchronously to the peripheral clock signal;
generating an acknowledgment signal synchronous to the processor clock signal after the processor has processed the interrupt request or while the processor is processing the interrupt request; and
generating an acknowledgment signal synchronous to the peripheral clock signal from the acknowledgment signal synchronous to the processor clock signal via a first logic to inform the peripheral unit about the processed interrupt request.

8. The method according to claim 7, wherein the first logic has a first flip-flop, which is clocked by the processor clock signal and whose input signal is at least indirectly the acknowledgment signal synchronous to the processor clock signal, and wherein the first logic has a second flip-flop for generating the acknowledgment signal, which is synchronous to the peripheral clock signal and is clocked by the peripheral clock signal and whose input signal is the output signal of the first flip-flop.

9. The method according to claim 8, wherein the first logic has a plurality of second flip-flops connected one behind the other, each of which is clocked by the peripheral clock signal, wherein the output signal of the last connected second flip-flop represents the acknowledgment signal synchronous to the peripheral clock signal.

10. The method according to claim 7, wherein a second logic generates, from the interrupt request sent synchronously to the peripheral clock signal, an interrupt request that runs synchronously to the processor clock signal and is supplied to the processor.

11. The method according to claim 10, wherein the second logic has a shift register whose input signal is the interrupt request sent synchronously to the peripheral clock signal or a signal synchronous to the interrupt request sent to the peripheral clock signal, wherein the second logic has a logic connected downstream to the shift register for detecting an edge of the output signal of the shift register, and wherein the second logic has a flip-flop, which is clocked by the processor clock signal, whose input signal is the output signal of the logic for detecting an edge and whose output signal is the interrupt request running synchronously to the processor clock signal.

12. The method according to claim 10, wherein the second logic generates a wake-up signal for the processor from the interrupt request sent synchronously to the peripheral clock.

13. The method according to claim 7, wherein the processor clock signal has a higher clock frequency than the peripheral clock signal.

14. The method according to claim 7, wherein the processor, the peripheral unit, and the first logic are part of wheel electronics for detecting at least one tire parameter of a tire, to which the wheel electronics are assigned, and wherein the method further comprises the steps:
measuring a tire parameter of the tire by a sensor of the wheel electronics;
generating a message about the tire parameter of the tire by the processor based on an interrupt request; and
transmitting the message by a transmitter of the wheel electronics.
